(19) United States
(12) Patent Application Publication
(10) Pub. No.: US 2008/0217075 A1
(43) Pub. Date: Sep. 11, 2008

(54) DUAL JOYSTICK DIRECTIONAL TEXT INPUT

(75) Inventors: Jonathan Ian Gordner, Seattle, WA (US); Bo Thiesson, Woodinville, WA (US); Kenneth Ward Church, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/831,279

(22) Filed: Jul. 31, 2007

Related U.S. Application Data
(60) Provisional application No. 60/893,057, filed on Mar. 5, 2007.

(51) Int. Cl. G06F 3/041

(52) U.S. Cl. 178/18.01

(57) ABSTRACT

The claimed subject matter provides for character selection based on two orthogonal directional inputs associated with two input controllers. Such character selection can include a dual-input selection component comprising two independent input directional controllers, wherein activating a directional input effectuates a selection. Further included is a grouping component that can group characters into sub-groups, and map sub-groups and characters to orthogonal directional inputs related to the two input controllers, whereby activating a direction input can select a particular sub-group or character mapped to that direction.

### CROSS-REFERENCE TO RELATED APPLICATION

This application claims the benefit of U.S. Provisional Patent application Ser. No. 60/893,057, filed Mar. 5, 2007, entitled “DUAL JOYSTICK DIRECTIONAL TEXT INPUT”, the entirety of which is incorporated by reference.

### BACKGROUND

Modern game-play devices have developed capabilities of powerful computers as integrated circuit technology has become more advanced and incorporated into such game-play devices. Where traditional game-play devices ran exclusively on removable media, such as floppy discs, compact discs (CDs), digital video discs (DVDs), etc., and interaction with such games was solely by way of a joystick or other game control device, modern game-play systems are not so limited. Rather, a modern device can utilize powerful network and computing applications such as e-mail, instant messaging, web browsing, digital video recording, and the like. Additionally, gaming has progressed to an online arena, where players can synchronize their gaming systems with other players via an online server, and communicate, coordinate, and interface with other remote players while playing a game. Typically, such communication and coordination, as well as game registration and character setup, requires some type of information exchange, most notably text chat.

Text chat has become an important aspect of modern video game consoles, including gaming consoles that facilitate online gaming. Traditional text chat implementations include text entry methods similar to entry of characters via a computer keyboard or similar keypad device. Such devices are collectively termed virtual keyboards (VKs). A VK device facilitates text entry by providing an onscreen replica of a physical keyboard (or similar key-pad device) and an online selection cursor mapped to buttons on a game controller or joystick. A user can select individual characters by moving a cursor via joystick movements, or other input segments, to a particular key of the VK representing a character and selecting that particular key (e.g., by pressing an accept button). Moving the cursor via the game controller or joystick to subsequent keys and selecting those keys facilitates selection of additional characters. However, this text selection method is an adaptation of a text entry method designed for different devices (e.g., physical computer keyboards) than game controllers, and is not always an efficient means to enter text on a console by way of game controllers. More specifically, such a device can be slow and tedious, as a cursor is typically moved from one position on a screen (e.g., representing a character or key) to another position subsequent each selection. Furthermore, because selections are typically based on a relative screen position of a key with respect to a prior selected key (or prior position of a cursor), a user is required to view the VK display in order to enter text, often distracting them from concurrent computing activities (e.g., responding to game stimuli). Consequently, eyes-off input is very difficult, and visual distraction associated with VK devices is difficult to avoid.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in accord with aspects thereof, provides for selection of text on a device via two directional inputs executed on at least one of two substantially orthogonal directional input controllers. A grouping component can associate characters with two or more character sub-groups and map the sub-groups (e.g., via a first tier mapping) and associated characters (e.g., via a second tier mapping) to substantially orthogonal direction inputs of the two input controllers. Selection of a sub-group can occur via a first substantially orthogonal controller input, and selection of a character can occur via a second substantially orthogonal controller input. Additionally, upon completion of a first character selection, the character sub-groups can be re-mapped to the input controllers to facilitate entry of an additional character(s). The claimed subject matter distributes at least one first tier mapping (e.g., a character sub-group) or one second tier mapping (e.g., text characters) across an orthogonal direction input of each of two or more orthogonal input controllers. As described, use of orthogonal direction input facilitates reliable ‘eyes-off’ character selection (e.g., in a sense that mis-selections are avoided), while mapping across multiple controllers enables availability of relatively large numbers of characters for dual-input selection.

In accordance with additional aspects of the claimed subject matter, dual orthogonal input controllers can facilitate menu-driven text entry. A grouping component can map sub-groups of characters to substantially orthogonal directional inputs of two controllers. Completion of a first orthogonal direction input can select one of the mapped sub-groups. A selected sub-group can then be displayed to a user via an on-screen and/or on-controller menu, providing characters within the sub-group for selection and text entry. Additionally, a default character can be highlighted enabling acceptance and selection of such default character by way of a single acceptance input. Alternatively, an intended character can be selected with a second orthogonal directional input of a controller, and selection of an intended character completed via the acceptance input.

According to additional aspects of the subject innovation, selection of a particular text entry mode can enable mapping of various sub-groups and associated characters to dual input controllers of an input control device. Text entry mode can include capital letter text, lowercase letter text, symbols, numbers, alternate alphabets, or the like. According to further aspects, character sub-groups associated with a default mode can be automatically re-mapped to the input controllers upon selection of a character from a non-default mode. As described, the subject disclosure provides a mechanism for entering text of various languages and alphabets, entering symbols, numbers, and the like, utilizing a dual orthogonal input in conjunction with selection of a particular mode. As a result, a reliable ‘eyes free’ way for entering alphabetic text can be expanded to encompass a much larger number of characters.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates an example block diagram of a system that provides text entry for game control devices via two-step selection of dual input controllers in accord with aspects of the claimed subject matter.

FIG. 2 illustrates a block diagram of an example system that provides text input via two-step orthogonal directional input associated with dual input controllers in accord with further aspects disclosed herein.

FIG. 3 depicts an example system that provides additional text selection features and language modes in conjunction with a dual orthogonal text selection mechanism in accordance with various aspects disclosed herein.

FIG. 4 illustrates an example methodology for selection of characters and sub-groups of characters by way of dual orthogonal direction input controllers in accord with various aspects disclosed herein.

FIG. 5 illustrates an example methodology for menu-driven text input according to aspects of the claimed subject matter

FIG. 6 illustrates an example dual input game controller input mechanism according to aspects of the claimed subject matter.

FIGS. 7A and 7B illustrate an example sub-group and character mapping of dual input orthogonal controllers according to various aspects disclosed herein.

FIG. 8 illustrates an example computing environment applicable to a modern game console in accord with aspects described herein.

FIG. 9 illustrates an example networking environment that can be incorporated into online communication, such as online gamine, as disclosed in the subject innovation.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, “entity data model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. As another example, an interface can include I/O components as well as associated processor, application, and/or API components, and can be as simple as a command line or a more complex Integrated Development Environment (IDE).

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

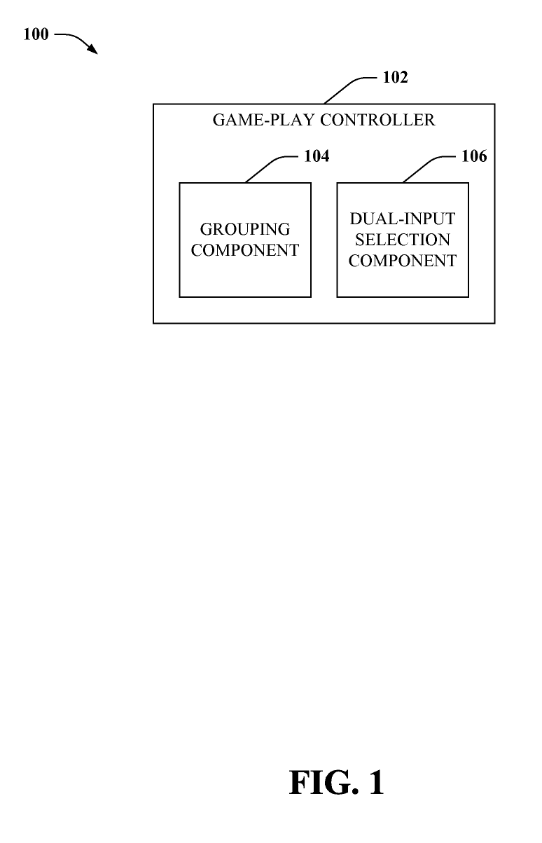

FIG. 1 depicts a system 100 that provides orthogonal, two-step text selection in accordance with aspects of the subject disclosure. System 100 includes a game-play controller 102 that can input and/or receive information related to a gaming console or gaming device. Examples of a gaming console/device include a computer, laptop, personal digital assistant (PDA), handheld video game player, compact disc (CD) and/or digital video disk (DVD) or like removable media game-play unit, and like devices. Game-play controller 102 can be any suitable input and/or output device related to computer-implemented gaming including, e.g., a joystick, game-pad, game controller, or like devices. Furthermore, game-play controller 102 can be a communication device that can, in addition to inputting and/or receiving information related to a gaming console or device, connect to a communication network and exchange data therewith, e.g., download data, media, etc. from the Internet or other suitable data network.

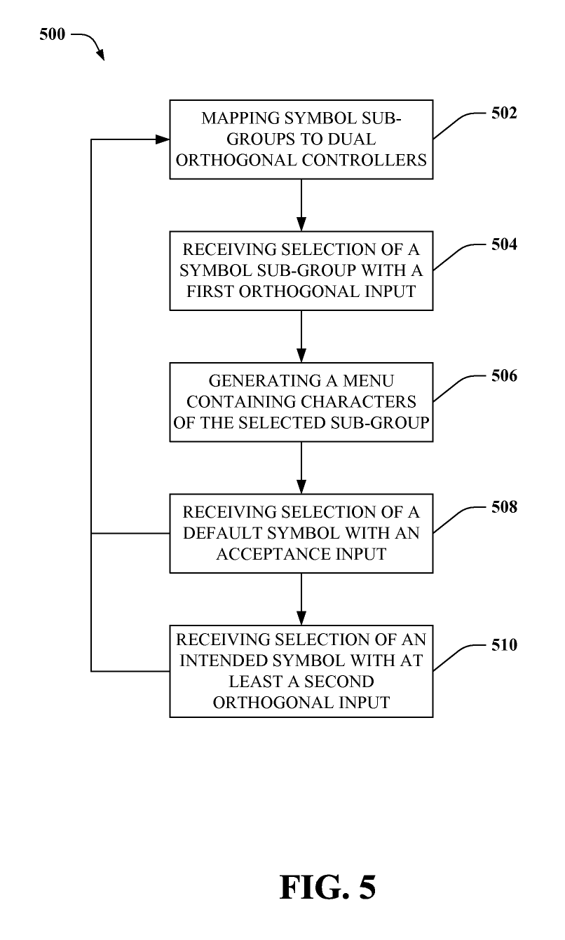

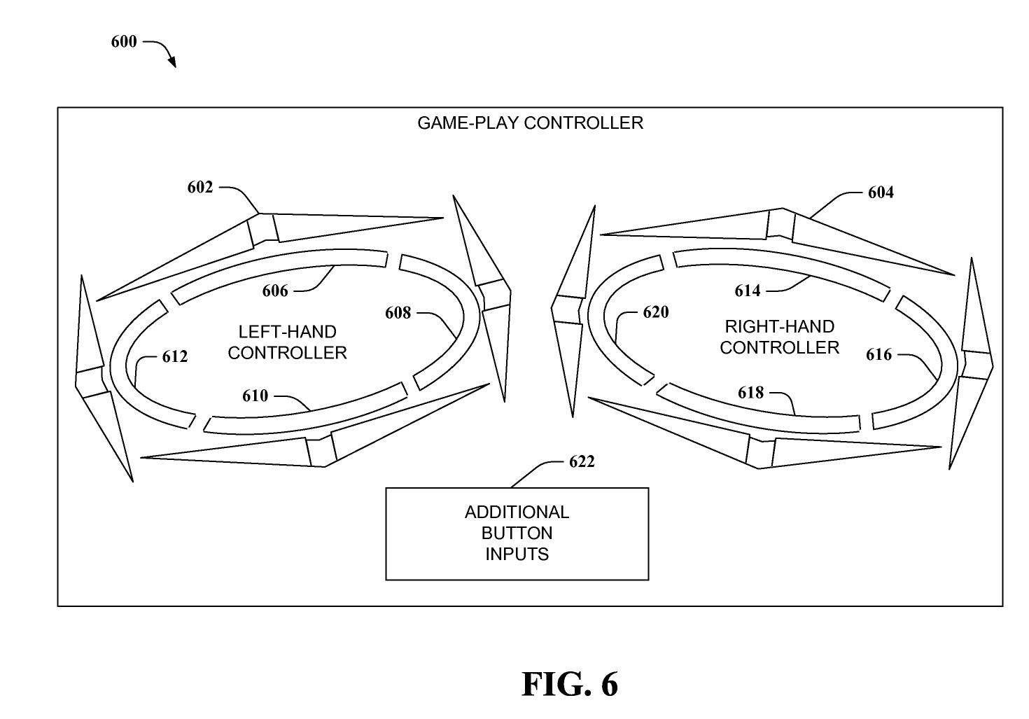

System 100 can facilitate entry of symbols (e.g., text) related to communication and/or gaming via game-play controller 102. More particularly, symbols can be entered by way of a reliable input on one or more substantially orthogonal input controllers (see FIGS. 5 and 6 for a detailed depicted of an example interface of an orthogonal input controller). (As used herein, the term ‘orthogonal’ can refer to any suitable set of substantially perpendicular axis, including left, right, up, down, in, out, etc., of a controller surface for instance, or like variations of a three dimensional directional axis.) A grouping component 104 can organize symbols into groups of text-based characters, e.g., alpha-numeric letters and numerals, keyboard characters, font symbols, of any suitable alphabet (e.g., Greek, Roman-numeral, Chinese, Japanese, etc.), dialect, etc., and can also organize other characters including, for example, emoticons, and the like. Groups of text-based symbols can be organized into multiple sub-groups, each sub-group having multiple characters. For example, the roman alpha-numeric characters, including 26 letters a through z and 10 numbers, 0 through 9, can be organized into sub-groups of multiple characters. As a more specific example, 8 sub-groups of characters, each sub-group containing between 2-5 characters is conceivable. Furthermore, each sub-group can be mapped to a dual-input selection component 106, so that a single selection of one or both of the dual inputs can select one or more sub-groups.

System 100 can further facilitate selection of characters via two independent selections of dual-input selection component 106. Dual-input selection component 106 can include at least two distinct input control devices (e.g., 2 thumb guided joysticks, 2 pen, stylus, or pointer inputs, etc., 2 guided inputs, or the like), where each controller can have one or more symbol sub-groups (e.g., formed by grouping component 104) mapped to orthogonal direction inputs of the controllers. For instance, a first controller input mapping can map the symbol sub-groups to one or more substantially orthogonal directions associated with the input controllers (e.g., see orthogonal targeting component 212, infra, and FIGS. 5 and 6, infra). A first substantially orthogonal directional input executed on one of the dual input controllers can select a symbol sub-group. A second controller input mapping can map symbols of the selected sub-group to the orthogonal direction inputs of one or more of the controllers. A second substantially orthogonal directional input executed on either of the dual input controllers (e.g., having a character mapped to the directional input) can select and/or enter a character within a symbol sub-group.

It should be appreciated that system 100 distributes at least one of a first tier mapping (e.g., character sub-groups to orthogonal direction inputs) or a second tier mapping (e.g., characters to orthogonal direction inputs) across at least one substantially orthogonal directional input of each of the dual input controllers of dual-input selection component 106 (e.g., as needed in order to provide a sufficient amount of orthogonal selection directions at each selection stage.) In addition to the foregoing, after selection/entry of a character, game-play controller 102 can re-map sub-groups to the dual input controllers (e.g., to directions relevant to such controllers, including left, right, up, down directions, or diagonals such as upper left, upper right, lower left, lower right, or similar sequences of substantially orthogonal directions) to facilitate selection of another character. Consequently, a subsequent substantially orthogonal selection of dual-input selection component 106 can select a symbol sub-group once again. System 100 therefore can enable selection of one or more characters of multiple sub-groups with a maximum of two directional input selections of dual-input selection component 106, such selections being substantially orthogonal.

System 100 further enables selection of text related to a game-play or game-play and communication device (102) for e-mail, web browsing, instant messaging, text chat, entering computing instructions such as text input-based searching and network browsing, etc. System 100 can further obviate tedious virtual keyboard text selection methods, by providing text input such that subsequent character selection and/or entry are independent of previous input. For example, virtual keyboard mechanisms require a user to select individual characters by moving a virtual pointer (on a display device, for example) across a display of characters similar to that depicted on a keyboard. Each entry requires the pointer to be moved from one character to the next character on the virtual keyboard. Such methods of text entry require a user to view the display device, as subsequent characters must be entered by moving the pointer from a virtual location related to a first selection to a virtual location of a subsequent selection.

System 100, and dual-input selection component 106, can enable eyes-off character entry (e.g., text entry without directly looking at game-play controller 102) via independent character selection, in contrast to a virtual keyboard device as described above. More specifically, because any two input selections utilized to select a second character are not related to input selections that select a prior character, unlike virtual keyboard models, a user can simply ‘memorize’ orthogonal selection patterns and enter characters without looking at an entry device (102). As a more specific example, a sub-group of letters ‘a’ through ‘c’ can be mapped to an ‘up’ direction associated with a first dual input controller (e.g., of dual-input selection component 106). Additionally, a second sub-group of letters ‘d’ through ‘g’ can be mapped to a ‘down’ direction associated with the first dual input controller. Upon selection of the ‘a’ through ‘c’ sub-group (e.g., via an ‘up’ selection of the first input controller), grouping component 104 can map characters ‘a’ through ‘c’ to at least 3 directions associated with the first and/or second input controller. Additionally, upon selection of the ‘d’ through ‘g’ sub-group, grouping component 104 can map characters ‘d’ through ‘g’ to at least four directions associated with the first and/or second input controller.

Continuing the established example, input of the word ‘dab’ can be performed with 6 selections, each pair of selections inputting a single character, and each pair of selections independent of a prior or subsequent selection or pair of selections. Inputting the letter ‘d’, in this example, could first utilize a ‘down’ selection (e.g., by moving a joystick in a ‘down’ direction, pressing a bottom directional button of a button pad, etc.) of the first input controller to select a ‘d’ through ‘g’ sub-group. Upon selection of the sub-group, grouping component 104 can automatically map characters ‘d’, ‘e’, ‘f’ and ‘g’ to, for instance, ‘left’, ‘up’, ‘right’, and ‘down’ positions, respectively, of the first and/or second input controller (alternatively, a character could be mapped to an ‘in’ direction, for example associated with pushing a joystick into game-play controller 102, or selecting a center button of a 5-button input controller, or the like). Therefore, performing a ‘left’ selection of the first, or alternatively the second, input controller can complete selection of the letter ‘d’. Upon completing selection of the letter ‘d’, grouping component 104 can automatically re-map symbol sub-groups, including sub-group ‘a’ through ‘c’ and sub-group ‘d’ through ‘g’, to directions associated with the two input controllers (e.g., substantially orthogonal directions).

Selection of the letter ‘a’ in the subject example would first employ an ‘up’ input of the first controller to select the ‘a’ through ‘c’ sub-group. Grouping component 104 could then automatically map characters ‘a’, ‘b’ and ‘c’ to, for instance, the ‘left’, ‘up’ and ‘right’ directions, respectively, associated with the first and/or second input controller. A second ‘left’ selection of the first, or alternatively the second, input controller can select the ‘a’ character. Selection of the ‘b’ character to complete entry of the letters ‘d“a”b’ to spell the word ‘dab’ can be with another ‘up’ selection of the first input controller followed by an ‘up’ selection of the first, or alternatively the second, input controller.

As the previous example illustrates, because repetitive input sequences can enable selection of a character, and because grouping component 104 can automatically re-map sub-groups to a same, or substantially same, selection position, successive character input is independent of related character input. Consequently, a user can enter text without having to look at game-play controller 102 after remembering which controller directions a sub-group and associated characters are mapped to. Selection sequences can easily be memorized facilitating text entry while performing other tasks, for instance, while interacting with a video game.

In addition to the foregoing, it should be appreciated that system 100 can provide for a reliable mechanism for entering text. For instance, non-orthogonal based controllers, such as 45 degree 8-direction controllers, 60 degree 6-direction controllers, and so on, can be much less reliable input mechanisms for text entry, especially with a gaming joystick device. To illustrate, gaming joystick devices (102) can have one or more input controllers typically controlled by the thumbs of one or both hands. Thumb movements, however, can be less precise than, for instance, finger index movements. Input devices that utilize sub-orthogonal inputs, e.g., inputs that fill substantially half of a quadrant, or substantially 45 degrees of a circle, can be much more error-prone, in regard to character selection, requiring slower character input. This can be due to the fact that sub-orthogonal inputs are typically smaller and more closely spaced than substantially orthogonal inputs, making it harder for a user to distinguish between different inputs. As a result, complicated or precise movements, such as 30, 45, or 60 degree movements, or twirling and/or multi-rotational movements can be difficult to master with thumb-guided input controllers. Such devices often require slower text input, or can generate multiple errors, especially for text entry concurrent with other computing actions (e.g., text entry concurrent with online gaming).

In contrast to the foregoing, orthogonal input, is typically more reliable and enables faster, more accurate text entry while performing multiple computing tasks. As a result, substantially orthogonal input controllers can reduce a likelihood of inadvertent characters, or input errors (e.g., typo), providing a very reliable input mechanism. Especially for thumb-guided inputs, a simple up-down-left-right type of input, for instance, can be much easier to navigate than controllers having more refined inputs (e.g., 60, 45, 30 degree inputs or the like, or swirling, rotational inputs). Therefore, the subject innovation provides for a fast and reliable mechanism for text entry on a gaming device as compared with conventional mechanisms.

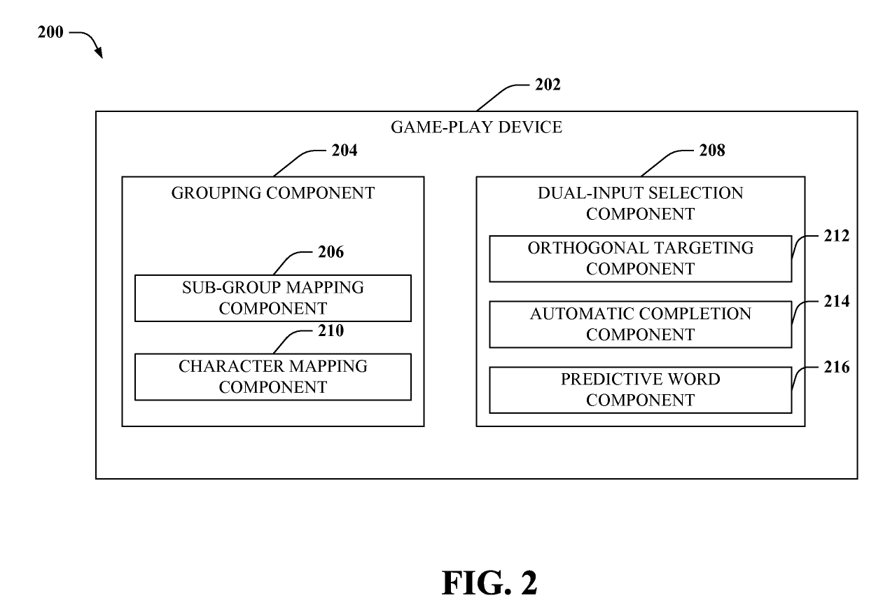

FIG. 2 depicts a system 200 that enables selection of text via dual-input orthogonal direction controllers in accord with aspects of the claimed subject matter. Orthogonal direction controllers can register input by, for instance, pressing one of four (or alternatively five or six in a three dimensional model) buttons substantially 90 degrees separate from each other (e.g., 4 buttons in a circular formation, each button aligned at one of four substantially 90 degree positions of a circle), pressing a portion of a control pad representing a quadrant of a circle, moving a joystick into an orthogonal quadrant of a circle, etc.

As discussed previously, orthogonal direction controllers can typically be more reliable for text entry than sub-orthogonal counterparts, because each directional input substantially fills a quadrant of a circle. Therefore, pressing an input controller in substantially any portion of a quadrant will render a particular input associated with that quadrant. Consequently, an increase in speed and reliability associated with text entry for thumb-guided input devices can result from substantially orthogonal input.

As described, system 200 can map text, symbols, characters and the like to sub-groups, and map the sub-groups to substantially orthogonal directions of one or more orthogonal input controllers. A single input can facilitate selection of a sub-group and a subsequent input can facilitate selection of a character. More particularly, grouping component 204 can group characters into such symbol sub-groups, each sub-group containing multiple characters. Additionally, sub-group mapping component 206 can map each sub-group to the one or more substantially orthogonal directions associated with the two input controllers of dual-input selection component 208.

According to one or more particular aspects, sub-group mapping component 206 can, for example, organize characters into sub-groups in accord with a use rating, where a use rating is dependent on objective language factors, such as the frequency of use of a character within a given alphabet, language, dialect, etc. (e.g., as illustrated by a typical use-frequency of the letters ‘t’, ‘r’, ‘s’ and ‘e’ in the English language). High use rating characters can be mapped, for instance, with other high use rating characters and subsequently mapped to an orthogonal input of one of the controllers determined most convenient to activate by a user. Alternatively, high use rating characters can be mapped into a sub-group with low use rating characters where the high use rating character is provided as a default selection (e.g., wherein a default selection is activated by an easily accessible input of game-play device 202). Additionally, sub-group mapping component 206 can automatically update and/or refresh sub-group mapping as characters are selected.

Character mapping component 210 can map characters of a sub-group to substantially orthogonal directions associated with one or both of the two input controllers of dual-input selection component 208. Mapping a set of characters can automatically occur, for instance, subsequent selection of a sub-group containing the set of characters. If characters are mapped to one orthogonal controller only, substantially orthogonal input related to the one controller can complete selection of a particular character. If characters are mapped to both orthogonal controllers, orthogonal input of either controller can complete selection of a particular character.

Dual-input selection component 208 can provide selection of symbol sub-groups and characters within such sub-groups via directional input from two orthogonal input controllers. Orthogonal targeting component 212 include two input control devices having multiple substantially orthogonal inputs, for example, two joysticks, two directional pads, two sets of 4 buttons, each substantially 90 degrees separate from each other, etc. Four orthogonal directions can be typical. Additionally, a fifth orthogonal input direction can be included, for example, as “in” directional input representing a direction into a plane (such plane, for instance, representing including a circle substantially encompassing four orthogonal inputs). Each orthogonal direction can have a sub-group or character mapped to it, such that completing an orthogonal direction input can select the mapped sub-group or character. Automatic completion component 214 enables automatic completion of a selection. For instance, a sub-group can be automatically selected by a single orthogonal input into a particular orthogonal direction mapped to the sub-group. Subsequent such an input, automatic completion component 214 can select the mapped sub-group, enabling character mapping component 210 to automatically map characters of the sub-group to orthogonal inputs of orthogonal targeting component 212. Following an additional orthogonal input, automatic completion component 214 can complete selection of a character, enabling sub-group mapping component to automatically re-map sub-groups to directional inputs of orthogonal targeting component 212.

An alternative aspect enables a verification or acceptance input to verify or complete selection of a character. For example, selection of a sub-group could automatically display a menu on a display device (e.g., via automatic completion component 214) containing the characters of the sub-group. A default character of a selected sub-group can be highlighted upon display for immediate selection via an acceptance input. Such default character can be selected utilizing two inputs, total. Other, non-default characters of a selected sub-group can be highlighted by a single directional input of orthogonal targeting component 212, and selected via an acceptance input. Such non-default characters can be selected utilizing three inputs, total. To facilitate selection of additional characters, sub-group mapping component 206 can then automatically re-map the sub-groups to the directional inputs of orthogonal targeting component 212.

In accordance with additional aspects of the claimed subject matter, system 200 can utilize predictive text mechanisms in conjunction with dual orthogonal input controllers, as described, to further facilitate accurate and efficient text entry. For instance, predictive word component 216 can reference a source of words, phrases, sentences, etc. related to a particular language, alphabet, dialect or the like, or, for instance, a prior text history of a user, and provide possible complete words, phrases, sentences, etc. consistent with selected characters. For example, if a user selects letters ‘t’ and ‘h’ utilizing mechanisms substantially similar to those described herein, predictive word component 216 can display, for instance, the words ‘the’, ‘there’, ‘these’, and other words beginning with ‘t’-‘h’ can be displayed. A user can scroll through a list of words displayed by predictive word component 216, and select a particular word with an acceptance input (not shown) of game-play device 202. Additionally, predictive word component 216 can reference words of a sentence entered by a user, and offer additional words to complete a sentence or phrase based upon, for example, common sentences, phrases, expressions, prior words, phrases, and sentences entered by a user (e.g., a user text entry history). A user can select an offered word, sentence, or phrase with an acceptance input. Upon receiving such acceptance input for a particular word, phrase, sentence, etc., predictive text component can enter such word, phrase, or sentence.

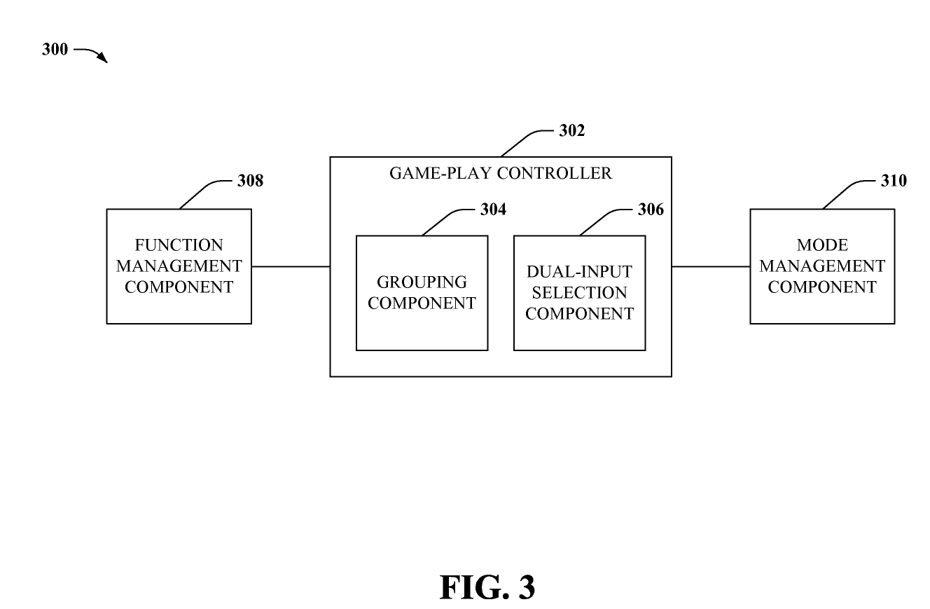

Referring now to FIG. 3, a system is depicted that can provide additional functionality for a text selection device as described herein. Such functionality can include text entry commands, common characters such as space, period, backspace, and the like. In addition, system 300 can switch between various text input modes, such as lowercase text mode, uppercase text mode, symbol mode, various sub-groups sizes, and the like. As a result, system 300 can provide for various system configurations that enable custom and/or diverse text entry in conjunction with a dual input text selection utilizing substantially orthogonal input controllers as described herein.

System 300 can facilitate entry of text utilizing two selections of one or more substantially orthogonal input selectors of a game-play device 302. Grouping component 304 can map text characters to one or more sub-groups. Additionally, grouping component 304 can map text of diverse types, such as lowercase, uppercase, diverse language characters, symbols (e.g., emoticons, mathematical symbols, or like symbols), and so on to additional sub-groups associated with such diverse types of text. In addition to the foregoing, dual input selection component 306 can facilitate entry and/or selection of characters via two selections on one or more substantially orthogonal input control devices (e.g., joysticks, button pads, etc.)

In addition to the foregoing, system 300 can also provide additional text input functionality. For instance, function management component 308 can map functions to additional input features (e.g., buttons) of game-play device 302. Such functions can include entry of common characters, symbols, etc., cursor movements to position a text entry cursor and the like. More specifically, functions that can be mapped to the additional input features can include a backspace, space, cursor forward and/or backward functions, return function (e.g., that return a state of a device to a prior mode, input selection entry, or the like), a toggle function that can toggle between one or more modes (e.g., between uppercase and lowercase or between number and symbol mode, or the like), a selection acceptance function that can be utilized in conjunction with pre-highlighted characters, as discussed above, a disable feature that can disable one or more functions associated with a game-play device 302 as described herein (e.g., such function can be used to disable predictive text), a selection scroll feature, or combinations thereof or of like functions. It should be appreciated that other features and functions, not specifically articulated herein but known in the art or made known to one of skill in the art by way of the context provided by the subject disclosure, can be incorporated with game-play device 302 by function management component 308. As a result, the accurate and efficient entry of text provided by a dual orthogonal entry system as articulated herein can be provided in addition to the benefits associated with such additional text entry features.

System 300 can also include disperse text entry modes in conjunction with dual orthogonal character entry, to facilitate text entry suitable to particular users of game-play device 302. More particularly, a mode management component 310 can switch between various text selection modes in accordance with the subject disclosure. According to particular embodiments, mode management component 310 can select between a dual orthogonal entry selection, and menu selection. Menu selection can include a first substantially orthogonal input that selects one of several sub-groups. Upon selection of a sub-group, characters forming the sub-group can be displayed on a menu screen (e.g., with a default character, such as a most popular character or a most recently selected character, or the like, highlighted for default selection). A user can then utilize addition input features (e.g., buttons, triggers, and the like) provided by function management component 308 for instance, to highlight an intended character, and select it.

According to additional aspects, mode management component 310 can provide for various sub-group mapping mechanisms. For instance, a default mechanism can include sub-groups with 3-5 characters, which are mapped to one substantially orthogonal direction of one or more orthogonal input controllers upon selection of the sub-group (e.g., selection of a sub-group can map characters to only one of two input controllers, or to both of the input controllers in a like manner). As an alternative, a mapping mechanism can include sub-groups having 8-10 characters that are each mapped to different substantially orthogonal inputs of two input controllers. Subsequently, a substantially orthogonal selection on either of the controllers can facilitate selection and entry of a character.

According to further embodiments, mode management component 310 can facilitate toggling between a default alphabet and language (e.g., English language, the Roman alphabet, Cyrillic alphabet, etc.), and additional alphabets, languages, and the like. Furthermore, selection of a default language, alphabet, etc. can be facilitated. Furthermore, non-text entities such as emoticons and similar graphical depictions can be mapped to sub-groups and toggled by mode management component 310. Still other aspects of system 300 can provide for including accents with a selected character (e.g., a user mode allowing entry of a character accent, selected by a menu, upon selection of the character). Further aspects of system 300 enable disperse character positioning (e.g., displaying characters within a sub-group similar to how they would be mapped to an input controller upon selection of the sub-group) within the sub-groups, different colors, highlights, visual accents, and the like in order to distinguish between one sub-group and another, or between characters within sub-groups. As described, system 300 can provide for various text selection efficiency features in addition to those provided by dual orthogonal selection, and also for switching between various modes, such as preferred modes of a particular device user.

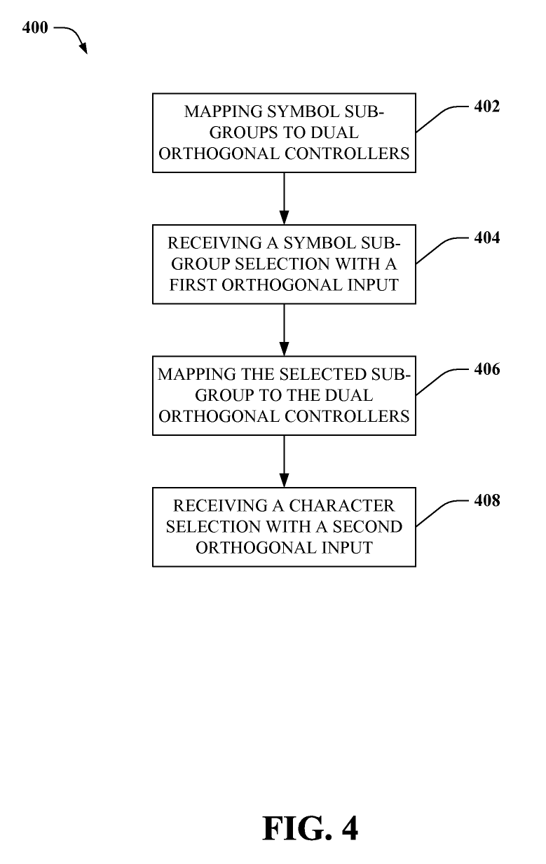

Referring now to FIG. 4, a methodology 400 is illustrated in accordance with the subject innovation. While, for purposes of simplicity of explanation, the methodologies are shown and described as a series of acts, it is to be understood and appreciated that the claimed subject matter is not limited by the order of acts, as some acts can occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts can be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers.

FIG. 4 depicts a sample methodology 400 for text input related to a game controller in accord with aspects of the claimed subject matter. At 402, symbol sub-groups are mapped to one or more substantially orthogonal input controllers. The symbol sub-groups can each contain multiple characters of an alphabet, language, dialect, font symbols, emoticon symbols, keyboard characters, or any suitable character used in text communication. Typically, each character of a particular character type (e.g., lowercase) will be included within only one of the multiple symbol sub-groups. The substantially orthogonal input controllers can include two distinct electronic communication input and/or output devices. Examples include two joysticks, two directional keypads, two rotational input pads, two groups of at last 4 buttons, where such buttons are positioned within substantially orthogonal quadrants of a circle with respect to each other, etc. Mapped sub-groups (e.g., each sub-group of characters concurrently mapped to a directional input of a controller) can be displayed near a substantially orthogonal direction of one or both controllers, indicating that a sub-group can be selected by performing an input associated with such substantially orthogonal direction.

At 404, a symbol sub-group selection is received by way of a first substantially orthogonal input. Such input can be, for instance, by pressing a button associated with a substantially orthogonal direction mapped to the selected sub-group, moving a joystick substantially into the orthogonal direction, pressing a keypad in a manner associated with the substantially orthogonal direction, etc. At 406, characters of the selected sub-group are automatically mapped to one or more of the input orthogonal controllers. For example, each character can be mapped to a substantially orthogonal direction associated with one or more of the controllers, in a similar manner as the sub-groups are mapped to directions of the controllers. Performing a substantially orthogonal direction input associated with one or more of the controllers, where such orthogonal direction is mapped to a character, can complete selection of the character. It should be appreciated that method 400 maps at least one symbol sub-group (e.g., at reference number 402) or one text symbol (e.g., at reference number 406) across at least one substantially orthogonal directional input of each of two input controllers.

At 408, a character selection can be received by way of a second orthogonal input. Such selected character can be the character mapped to the second orthogonal input at reference number 406. As described, methodology 400 enables entry of a wide variety of text-based characters by way of two substantially orthogonal inputs. In such a manner, a user can quickly and reliably enter text while simultaneously performing other computing tasks (e.g., playing a video game).

FIG. 5 depicts a sample methodology 500 providing an alternative mechanism for selecting text with a game control device in accord with various aspects of the claimed subject matter. At 502, symbol sub-groups are mapped to dual orthogonal controllers. Such mapping can be, for instance, to different orthogonal directional inputs of such controllers. Further, the dual orthogonal controllers can include two joysticks, two directional keypads, etc. as described supra. Additionally, the symbol sub-groups can be displayed on the game control device near the orthogonal direction inputs that they are mapped to. As an example, sub-group characters can be displayed via indicator lights near orthogonal input directions (e.g., in an ‘up’, ‘down’, ‘left’, ‘right’ direction relative to a controller position). Moving a controller in a particular orthogonal input direction can select a sub-group mapped thereto.

At 504, a symbol sub-group is selected with a first orthogonal input. Such orthogonal input can be, for instance, moving a joystick into an orthogonal direction, selecting a button associated with an orthogonal direction, moving a keypad into an orthogonal direction etc. At 506, a menu indicating characters associated with the selected sub-group can be displayed. In accord with particular aspects, a default character can be highlighted upon display of the menu at act 506. Selection of the default symbol can be, for instance, by way of an acceptance input. Furthermore, default characters can be chosen via a use-rating associated with such a character, where characters utilized often within a particular alphabet, language, dialect, etc., or used often by a particular user, or both, can be given a higher use rating than other characters. Additionally, symbol sub-groups can be composed such that each sub-group has one high use character, to increase a likelihood that each high use character will be a default character of a displayed character menu.

At 508, a default character is selected with an acceptance input. Such a default character can be a relatively high-use character, as described above. Completion of selection can cause symbol sub-groups to be automatically remapped to orthogonal directions of the dual orthogonal controllers, at 502. Alternatively, at 510, an intended symbol, other than the default symbol, can be selected with a second orthogonal input and the acceptance input. Such an intended symbol can be a lower-use character, relative to the default character. Completion of character selection at 510 can also cause symbol sub-groups to be automatically remapped to orthogonal directions of the dual orthogonal controllers, at 502.

Referring now to FIG. 6, an exemplary game-play controller 600 is depicted in accord with aspects of the claimed subject matter. Game-play controller 600 includes two orthogonal input controllers, left-hand controller 602 and right-hand controller 604. Left-hand orthogonal input controller 602 can be manipulated by, for example, a thumb, finger, stylus, pen, etc. of a user's left hand. The substantially oval ring portion of the orthogonal input controller has four active segments, 606, 608, 610, and 612, which can receive orthogonal direction inputs by being pressed, rotated toward, or like controller input. Arrows adjacent to the ring portions indicate an orthogonal direction associated with each substantially orthogonal ring portion segment (606, 608, 610, 612). In accord with aspects of the subject innovation, described herein, symbol sub-groups and characters associated with such sub-groups can be mapped to segments of orthogonal input controller 602, enabling selection of such sub-group or character by selection of one of the segments (606, 608, 610, 612) mapped to an orthogonal direction.

In substantially similar fashion as left-hand input controller 602, right-hand input controller 604 can be manipulated by, for example, a thumb, finger, stylus, pen, etc., of a user's right hand. Segments (614, 616, 618, 620) associated with right-hand controller 604 can also be mapped to orthogonal directions (indicated by arrows adjacent to such segments 614, 616, 618, 620), where activating the segments (614, 616, 618, 620) can activate a character or sub-group mapped to such orthogonal direction related thereto.

Additional button inputs 622 can include game-pad inputs (e.g., buttons, wheels, roller pads, ball pads, scrolling devices, etc.) facilitating alternate text input functions. For example, such alternate functions can include an input selection mode, an acceptance input, command inputs including, for instance, backspace, forward space, erase, cursor control moving a cursor one space forward or back, uppercase/lowercase toggle, number/symbol/letter toggle, toggling prediction on/off, scrolling through prediction options, etc. Input selection modes mapped to additional button inputs 622 can include, for instance, a lowercase alphabet, an uppercase alphabet, number, symbol, letter, lowercase accent characters, uppercase accent characters, international selection mode (e.g., that selects a particular alphabet and/or dialect different from a default alphabet and/or dialect) and like character modalities. In addition, an alternate, non-default mode can revert back to the default mode (e.g., uppercase non-default mode can revert to lowercase default mode) upon selection of a character in accord with the non-default mode. Furthermore, additional button inputs 622 can be mapped to different functions specified herein, for example, by a user-editor menu of game-play controller 600.

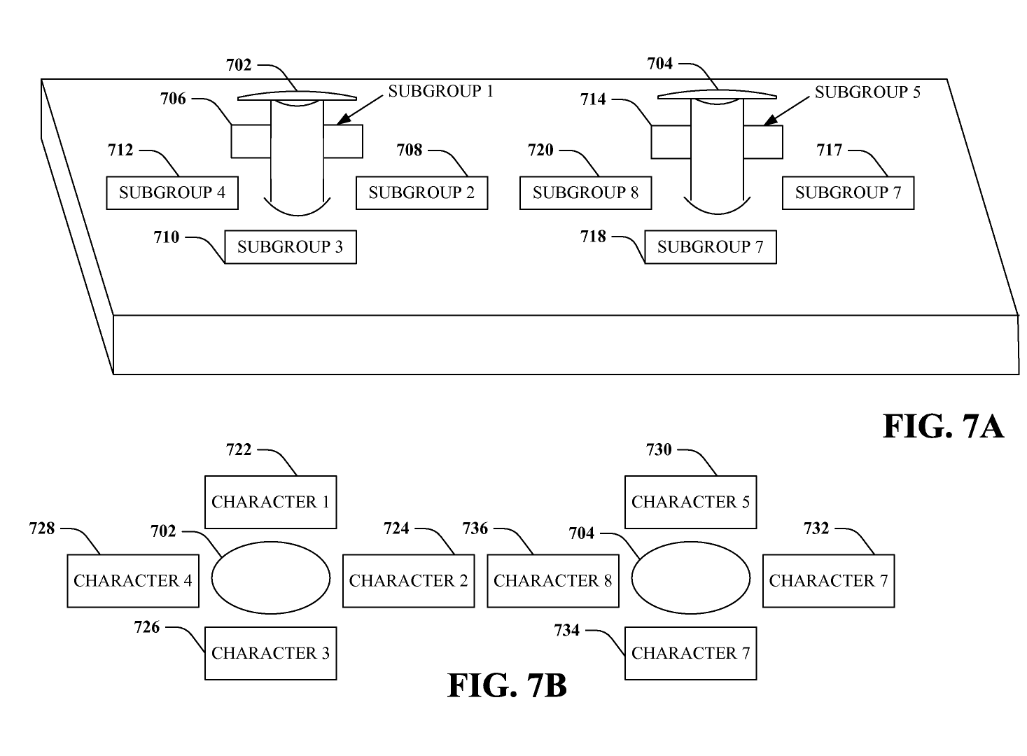

FIGS. 7A and 7B depict an example input mechanism for a game-controller in accord with aspects of the subject innovation. Joysticks 702 and 704 are thumb-controlled joysticks used for directional input related to game-play and/or text communication. Subgroups 1-8 (706-718) are symbol sub-groups each containing multiple characters, as described herein, mapped to orthogonal directions of joysticks 702 and 704. Moving either joystick 702 or joystick 704 can cause a particular subgroup (706-718) to be selected. Further, selecting a particular symbol sub-group can cause characters associated with such sub-group to be mapped to the orthogonal directions of one or both joysticks (702, 704). For example, FIG. 7B depicts a top-down view of character selection associated with FIG. 7A. In the particular example indicated in FIG. 7B, eight characters (722-736) associated with a particular symbol sub-group (e.g., subgroup 1 706) can be mapped to eight orthogonal directions associated with joystick 702 and 704. An orthogonal input of either joystick 702 or joystick 704 can complete selection of a character. For example, if subgroup 1 706 is selected by an initial ‘up’ orthogonal input associated with joystick 702, all characters associated with subgroup 1 706 can be mapped to the orthogonal directions of joystick 702 and/or joystick 704. Selecting a ‘down’ directional input of joystick 704, subsequent character mapping, will complete selection of character 7. Subsequent selection completion, sub-groups (706-720) can be re-mapped to the orthogonal inputs of joysticks 702 and 704.

In accord with the example embodiment depicted in FIGS. 7A and 7B, each subgroup has up to eight (or ten, see infra) characters associated therewith, and each of up to eight characters is mapped to one of eight orthogonal directions. In accord with other aspects of the subject disclosure, a maximum of four characters (or five, see infra) can be included in each subgroup, where each of the four characters can be copied to the same four orthogonal directions of joysticks 702 and 704, such that a substantially similar orthogonal direction input of either joystick can select a particular character. Alternatively, each of four characters can be mapped only to orthogonal directions of a single joystick (702, 704) so as to reduce display information and/or to alternate between the joystick used for selection of the sub-group and the joystick used for the final selection of the character in the sub-group. In accord with additional embodiments, a 5^{th} orthogonal direction (not shown) can be implemented, for example in/or out of a game-play device, enabling up to ten characters and/or sub-groups to be mapped to up to 10 orthogonal directions of joysticks 702 and 704 (or 5 characters and/or sub-groups where characters are mapped to a single joystick or copied to both joysticks).

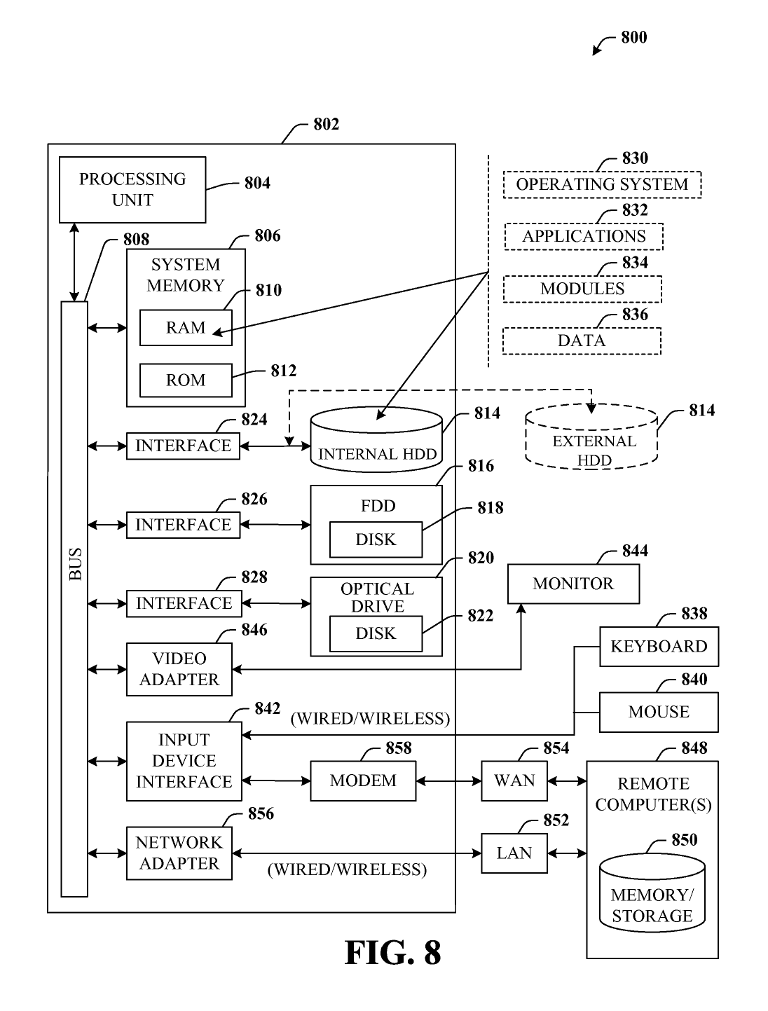

Referring now to FIG. 8, there is illustrated a block diagram of an exemplary computer system operable to execute the disclosed architecture. In order to provide additional context for various aspects of the subject invention, FIG. 8 and the following discussion are intended to provide a brief, general description of a suitable computing environment 800 in which the various aspects of the invention can be implemented. Additionally, while the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 8, the exemplary environment 800 for implementing various aspects of the invention includes a computer 802, the computer 802 including a processing unit 804, a system memory 806 and a system bus 808. The system bus 808 couples to system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE1394 interface technologies. Other external drive connection technologies are within contemplation of the subject invention.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 812, including an operating system 830, one or more application programs 832, other program modules 834 and program data 836. All or portions of the operating system, applications, modules, and/or data can also be cached in the RAM 812. It is appreciated that the invention can be implemented with various commercially available operating systems or combinations of operating systems.

A user can enter commands and information into the computer 802 through one or more wired/wireless input devices, e.g., a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE1394 serial port, a game port, a USB port, an IR interface, etc.

A monitor 844 or other type of display device is also connected to the system bus 808 via an interface, such as a video adapter 846. In addition to the monitor 844, a computer typically includes other peripheral output devices (not shown), such as speakers, printers, etc.

The computer 802 may operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adapter 856 may facilitate wired or wireless communication to the LAN 852, which may also include a wireless access point disposed thereon for communicating with the wireless adapter 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 9BaseT wired Ethernet networks used in many offices.

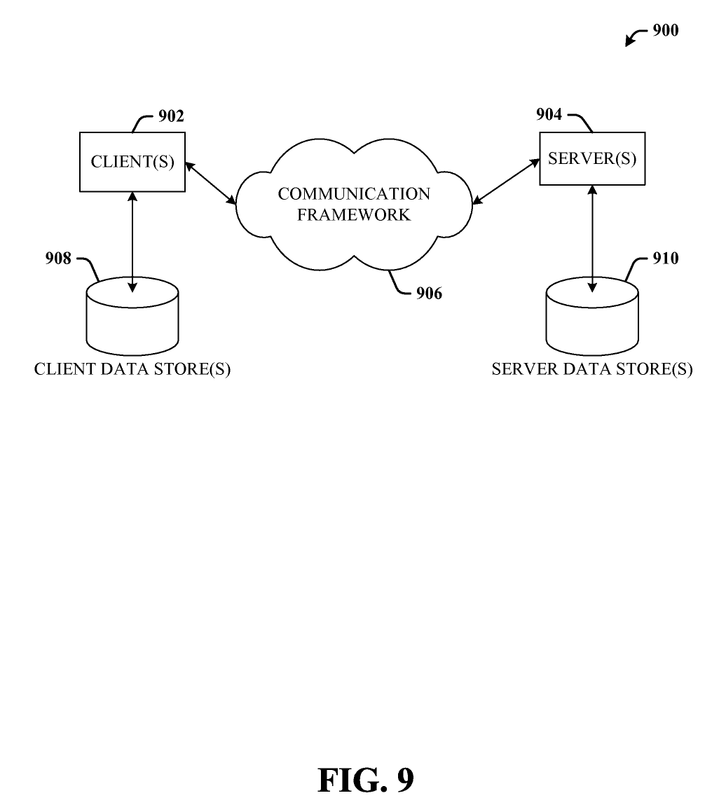

Referring now to FIG. 9, there is illustrated a schematic block diagram of an exemplary computer compilation system operable to execute the disclosed architecture. The system 900 includes one or more client(s) 902. The client(s) 902 can be hardware and/or software (e.g., threads, processes, computing devices). The client(s) 902 can house cookie(s) and/or associated contextual information by employing the invention, for example.

The system 900 also includes one or more server(s) 904. The server(s) 904 can also be hardware and/or software (e.g., threads, processes, computing devices). The servers 904 can house threads to perform transformations by employing the invention, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 909 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that provides directional text input for game control devices, comprising:
a grouping component that arranges multiple characters into sub-groups, and maps a character and a sub-group to substantially orthogonal directional inputs of two input controllers of a game-play device, at least one character or at least one sub-group is mapped to one of the substantially orthogonal directional inputs of each of the two controllers; and
a dual-input selection component that selects a character based at least in part on two substantially orthogonal directional inputs of at least one of the two input controllers.

2. The system of claim 1, wherein moving a controller in an orthogonal direction selects a character or sub-group mapped to the orthogonal direction.

3. The system of claim 1, comprising a sub-group mapping component that maps a high-use rating character within a high-use rating sub-group, and maps the high-use rating sub-group to a substantially orthogonal direction of an input controller determined most convenient for selection.

4. The system of claim 3, the high-use rating of a character is formulated at least in part on a typical use-frequency of the character within a selected alphabet, language, or dialect, or combinations thereof.

5. The system of claim 1, wherein characters of a sub-group are automatically mapped to substantially orthogonal directional inputs of one or both of the input controllers upon selection of the sub-group.

6. The system of claim 1, the input controllers include thumb controlled joysticks, directional button pads, 4 substantially orthogonally placed buttons, or a 5-button pad, having 4 buttons situated substantially within one of four orthogonal quadrants of a circle, and a fifth button in the center of the circle, or a combination thereof.

7. The system of claim 1, comprising a predictive text component that can reference a source of words, terms, or phrases, or a combination thereof, related to a particular language, alphabet, or dialect or a combination thereof, and a list of possible complete words that are consistent with a set of selected characters.

8. The system of claim 1, comprising a function management component that facilitates mapping cursor control, backspace, space, delete, return, lowercase/uppercase toggle, number/character toggle, character/symbol toggle, or predictive text component activation/deactivation functions, or a combination thereof, to additional input control mechanisms of the game-play device.

9. The system of claim 1, comprising a mode management component that can facilitate toggling between one or more modes of the game-play device.

10. The system of claim 9, the one or more modes comprise an uppercase mode, a lowercase mode, a symbol mode, a numeral mode, at least one diverse language mode, at least one diverse alphabet mode, a single or dual character mapping mode, a graphical entity selection mode, or combinations thereof.

11. A method for providing orthogonal directional input for character selection, comprising:
mapping multiple symbol sub-groups to substantially orthogonal inputs of at least one of two input controllers;
receiving a symbol sub-group selection by way of a first, substantially orthogonal input; and
receiving a character selection associated with the symbol sub-group by way of a second, substantially orthogonal input, receipt of the character selection or the sub-group selection based at least in part on a character or a sub-group being mapped to a substantially orthogonal directional input of each of the two input controllers.

12. The method of claim 11, comprising generating a menu containing characters of the symbol sub-group, wherein a default character is highlighted.

13. The method of claim 12, comprising facilitating selection of the default character with an acceptance input.

14. The method of claim 12, comprising facilitating selection of an intended character with a second orthogonal input and an acceptance input.

15. The method of claim 11, comprising mapping characters of the selected symbol sub-group to the substantially orthogonal inputs upon selection of the symbol sub-group.

16. The method of claim 11, comprising providing multiple sub-group modes, wherein each sub-group mode includes sub-groups mapped to characters of a diverse alphabet, a diverse language, or to numerals, or combinations thereof.

17. The method of claim 11, comprising displaying words for predictive text selection that are consistent with prior selected characters.

18. A system that provides orthogonal directional text input, comprising:
means for grouping characters into a sub-group;
means for mapping the sub-group to a substantially orthogonal direction input of at least one of two input controllers of a game-play device;
means for receiving selection of the sub-group upon activation of the substantially orthogonal direction input; and
means for receiving selection of a character upon activation of a substantially orthogonal direction input mapped to the character, receipt of the character selection or the sub-group selection is based at least in part on a character or a sub-group being mapped to a substantially orthogonal directional input of each of the two input controllers.

19. The system of claim 18, comprising means for mapping a character of a selected sub-group to one of the plurality of substantially orthogonal direction inputs of at least one of the two input controllers.

20. The system of claim 18, comprising means for entering a character upon activation of two orthogonal directional inputs of the game-play device.
